(19) United States
(12) Patent Application Publication
(10) Pub. No.: US 2010/0150520 A1
(43) Pub. Date: Jun. 17, 2010

(54) METHOD AND SYSTEM FOR CONTROLLING PLAYBACK OF A VIDEO PROGRAM INCLUDING BY PROVIDING VISUAL FEEDBACK OF PROGRAM CONTENT AT A TARGET TIME

(75) Inventors: Shawn Hopwood, San Francisco, CA (US); Pierre Lemieux, San Mateo, CA (US)

Correspondence Address: Dolby Laboratories Inc., 100 Potrero Avenue, San Francisco, CA, 94103-4938, US

(73) Assignee: DOLBY LABORATORIES LICENSING CORPORATION, San Francisco, CA (US)

(21) Appl. No.: 12/630,287

(22) Filed: Dec. 3, 2009

Related U.S. Application Data
(60) Provisional application No. 61/138,181, filed on Dec. 17, 2008.

(51) Int. Cl. H04N 5/93; G09G 5/00; G06F 3/048

(52) U.S. Cl. 386/52; 345/660; 715/838

(57) ABSTRACT

In a class of embodiments, a method for controlling playback of a video program by a media player including by providing visual feedback (referred to as a thumbnail) indicative of content of the program at a target location, a media player configured to perform any embodiment of the method, and a computer readable medium which stores code for implementing any embodiment of the method. Preferably at least one thumbnail is displayed and updated in real-time during playback of the program. Typically each thumbnail is a compressed or reduced-scale version of a frame of the program at, or a representative image of a segment of the program including, the target location. Typically, the thumbnail is an element of a displayed timeline control also including a timeline and an icon, position of the icon along the timeline indicates the target location, and the icon is movable along the timeline in response to user selection of different target locations (typically by asserting commands to the media player using a mouse or other input device). Preferably, data determining each thumbnail are computed prior to playback of the program, and the data and the program are stored prior to playback of the program.

### CROSS REFERENCE TO RELATED APPLICATIONS

This application claims priority to U.S. Provisional Patent Application No. 61/138,181, filed 17 Dec. 2008, hereby incorporated by reference in its entirety.

### BACKGROUND OF THE INVENTION

1. Field of the Invention

The present invention relates to methods and systems for controlling playback of a video program (e.g., multimedia data including video data). In typical embodiments, a media player's user interface displays a timeline control including an icon that can be moved along a timeline using a mouse or other input device to select a time within a displayed video program to which the media player will jump in response to a user command, and a thumbnail (or other indication of video content) indicating content of the video program at the time corresponding to the icon's current position along the timeline.

2. Background of the Invention

Throughout this disclosure including in the claims, the expressions “video” and “video program” are used interchangeably in a broad sense to denote both video data (that can be displayed by or using a media player) or multimedia data that includes video data (displayable by or using a media player) and other data (e.g., audio data); and the content indicated by video data or by multimedia data that includes video data. For example, “video program” can denote either video data, or video content provided by playback of video data.

Throughout this disclosure including in the claims, the expression “media player” is used in a broad sense to denote either software (or firmware) for programming a processor or processing system to play or play back video data and/or multimedia data including video data (e.g., multimedia data including both audio data and video data), or a system or device (e.g., notebook computer, PDA, handheld data storage and playback device, or other portable device) configured to play or play back video data and/or multimedia data including video data (e.g., a device that has been programmed with media player software). Herein, the expressions “playback,” “play back,” and “play” are used as synonyms to denote display of video data and/or playback of audio or other nonvideo content. Typical conventional media players are configured to play back files of video data (and/or files of other multimedia data including video data) having any of a variety of media formats.

Throughout this disclosure including in the claims, the expression “target location” in a video program being played (or to be played) by a media player denotes a location (i.e., a frame or other element) within the program to which the media player will jump in response to a user-entered command. Thus, each target location in a video program corresponds to a time (sometimes referred to herein as a “target time”) during the program that corresponds to the target location.

Typical conventional media players (e.g., Windows Media Player 10, CinePlayer 3.9.1 available from Sonic Solutions, DivX 0.9 for Windows Mobile 5/6 and some versions of Adobe Flash 9) have a user interface that can display a timeline control bar (including a timeline indicating times at which elements of a video program sequentially occur) during playback of the video program (e.g., a music video). By interacting with the timeline control bar (typically using an input device to drag a displayed icon along the displayed timeline) a user can jump quickly to an element of the program that occurs at a specific selected time (an elapsed or remaining time) in the program. The timeline of the user interface implemented by CinePlayer 3.9.1 includes marks that indicate start times of chapters of a DVD video program, allowing a user to interact with the timeline control bar to select the times indicated by these marks to jump successively from one chapter of a DVD to a previous or successive chapter during playback of the DVD. However, until any of the conventional media players begins to play back the program at the selected time, the user can only guess what content will be displayed when playback at the selected time begins.

It is conventional to begin playback of a stored video program at a selected time in the program by displaying thumbnails (each indicating content of the video program at a different time within the program), selecting one of the displayed thumbnails, and beginning playback at the time corresponding to the selected thumbnail. For example, Japanese Patent Application Publication No. 2006-279267, published Oct. 12, 2006, describes a system which stores a video program and thumbnails of scenes of the program, and can simultaneously display several of the thumbnails. A user can command the system to scroll through displayed thumbnails to display different ones of the thumbnails as a “main” thumbnail in a central position, and can command the system to begin playback of the program at the time corresponding to the current “main” thumbnail. Apparently, neither thumbnails nor a timeline control including thumbnails are displayed while a program is played back. Thus a system user considering whether to jump to a new location in a program during playback would need to cease playback, and cause the system to enter a non-playback mode in which it displays thumbnails and allows the user to select one of the displayed thumbnails to cause playback to begin at a time corresponding to the selected thumbnail.

### BRIEF DESCRIPTION OF THE INVENTION

In a class of embodiments, the invention is a method for controlling playback of a video program by a media player including by providing visual feedback (e.g., visually intuitive feedback) indicative of content of the program at a selected target location in the program (to which the media player will typically be implemented to jump in response to an appropriate user command). This feedback indicative of target location content will be referred to herein as a “thumbnail.” Each thumbnail is visually indicative of content of the video program at a time (a “target time”) within the program corresponding to the target location. The method typically includes a step of updating a displayed thumbnail in response to user selection of a sequence of different target locations (i.e., displaying a sequence of thumbnails, each having appearance indicative of content of the program at different one of the target locations). In typical embodiments, each thumbnail (or each of at least a subset of the displayed thumbnails) is a compressed or reduced-scale version of an actual frame of the program, or a representative image of a chapter (or other segment) of the program including the current target location. In other embodiments, each thumbnail (or each of at least a subset of the displayed thumbnails) provides some other visual indication of content of the program at a target location.

In preferred embodiments, the method provides and updates at least one thumbnail in real-time during playback of a video program. In accordance with preferred embodiments, a media player provides (including by displaying) not only a thumbnail but also visual feedback indicative of a current target location (i.e., current target time) in the program, and preferably the media player is operable to provide the thumbnail and feedback during playback of the program. For example, the thumbnail and visual feedback of current target location can be elements of a timeline control displayed so as to overlie a portion of each displayed frame of the program being played back. Alternatively, the thumbnail (and other visual feedback) and video program are displayed in different areas of a display screen so that neither overlies the other. Preferably, the method includes a step of providing the media player with predetermined data (e.g., pre-generated compressed versions of frames of the program) sufficient to display each thumbnail, thereby reducing or minimizing computational overhead and communication bandwidth required to display feedback in accordance with the invention.

In typical embodiments, the step of providing the thumbnail includes the step of displaying a timeline control including a timeline, an icon, and the thumbnail. The current position of the icon (and typically also the thumbnail) along the timeline indicates a target location and thus a target time in the video program, and the icon is movable along the timeline in response to user selection of different target locations in the video program (typically accomplished by asserting commands to the media player using a mouse or other input device). Typically, the thumbnail moves with the icon in response to user selection of different target locations. The thumbnail's current (updated) appearance visually indicates content of the video program at the relevant target location (i.e., at a target time and target location corresponding to the icon's current position along the timeline). The displayed timeline control is an improved version of a traditional timeline control bar displayed by the user interfaces of conventional media players.

In preferred embodiments, the inventive method for controlling a media player's playback of a video program includes the step of displaying a timeline control including a timeline, an icon, and a thumbnail, such that current position of the icon (and typically also current position of the thumbnail) along the timeline indicates a target location within the video program, and current appearance of the thumbnail indicates content of the video program at the target location (i.e., at a time corresponding to the icon's current position along the timeline). Preferably the method includes the step of updating the display by moving the icon (and preferably also the thumbnail) along the timeline to select a new target location, and preferably also updating the thumbnail's appearance to indicate content of the video program at the new target location. Preferably the method includes a step of playing the video program while displaying the timeline control. Typically the displayed timeline control overlies (is displayed in place of) a portion of each displayed frame of the program. Alternatively, the timeline control and video program are displayed in different areas of the display screen so that neither overlies the other. The media player can be implemented to display the timeline control initially with the icon but without the thumbnail and then, in response to an appropriate command (e.g., in response to user activation of the control by clicking on the displayed control using a mouse) to display the thumbnail adjacent to the icon (e.g., so as to overlie a portion of each displayed frame of the video program). Preferably, the thumbnail's appearance changes in real-time as the user causes the icon to move along the timeline and visually conveys to the user content (e.g., an aspect of or information about the content) of the video program at the icon's current location along the timeline. For example, the thumbnail may be a compressed or reduced-scale version of an actual frame of the program, and/or a chapter number, or a representative image of a target chapter of the program. By viewing the thumbnail, the user can intuitively select a target location within the program to which to command the media player to jump.

Preferably data determining the thumbnails are computed prior to playback of the program from video data comprising the program, and both the thumbnail data and program are stored (e.g., in the media player) prior to playback of the program. Alternatively, the thumbnails are generated (e.g., in the media player) from video data comprising the program in real-time during playback of the program. In some embodiments, thumbnail data are generated automatically for each of a sequence of regularly spaced locations within the program. In other embodiments, thumbnail data are determined for each of a set of scene changes or other logical break points under editorial control. Generation and storage of thumbnail data (that determine each thumbnail that may be displayed) in advance of playback minimizes or reduces computational overhead and communication bandwidth required to display a timeline control and thumbnails during playback of a program in accordance with the invention, and can allow the media player to load data determining an entire set of thumbnails for a video program without performing any operation on the video program.

Other aspects of the invention are a media player programmed (or otherwise configured) to perform any embodiment of the inventive method, and a computer readable medium which stores code for implementing any embodiment of the inventive method. In some embodiments, the inventive media player is software (or firmware) that programs a processor (or processing system) to perform an embodiment of the inventive method. In other embodiments, the inventive media player is a device or system programmed with software and otherwise configured to perform an embodiment of the inventive method. In other embodiments, the inventive media player is a device or system programmed with firmware and otherwise configured to perform an embodiment of the inventive method. Typical embodiments of the inventive media player are configured to allow a user to select a target location (a target playback position) within a video program, including by viewing content of the program (indicated by a displayed thumbnail) at each of a number of potential target locations while viewing the video program as it is played by the media player.

Some embodiments of the inventive media player implement (e.g., include or are programmed with) a user interface that can display a timeline control during playback of a video program, or before a user initiates playback, or during a pause in playback of the program. The user can interact with the timeline control (using a mouse or other input device coupled to a processor of the media player) to select a target location within the video program. The timeline control includes a timeline indicating times at which elements of the video program sequentially occur, and a control icon (an “icon”) which can be dragged or otherwise moved along the timeline by a user using a mouse or other input device to select a target location within the video program (to which the media player will jump in response to a user command asserted using the same input device or a different input device). The timeline control also displays a thumbnail indicative of content of the program at the target location, either when the timeline control is initially displayed or when the user activates the displayed timeline control. The displayed thumbnail indicates content associated with the current position of the icon (e.g., content of the video program at a time corresponding to the icon's current position). Preferably, the appearance of the displayed thumbnail changes in real time as the user interacts with the timeline control (e.g., drags the icon along the timeline) to select different target locations of the program along the displayed timeline, such that the current appearance of the timeline control (including the thumbnail) visually conveys to the user not only the icon's current location along the timeline (and thus a currently selected target time within the video program) but also content of the video program associated with the target time. After interacting with the timeline control to select a target time, the user can assert a command (a “jump” command) to a processor in the media player to cause the media player to jump to the target time in the program and play back the program commencing at the target time. In different implementations of the media player, the displayed thumbnails are indicative of content of different types, including for example actual scenes (e.g., compressed versions of actual frames) of the video program, chapter numbers, or representative scenes of the video program.

In operation of preferred embodiments of the inventive media player, playback of a video program (sometimes referred to as the “main program”) continues while a user interacts with a displayed timeline control by moving an icon (indicative of target location within the program) along a timeline and views changes in appearance of a displayed main thumbnail indicative of content of the program at the currently selected target location. Preferably, a double click on the icon causes the media player to jump to the main program element at the target location (the time within the program corresponding to the icon's current position) and to commence playback of the main program at the target location, thereby initiating playback of content indicated by the main thumbnail's appearance (at the time of the double click). In some embodiments of the inventive media player, during playback of the main program, additional thumbnails are displayed along the timeline (e.g., below the timeline while the above-described main thumbnail is displayed above the timeline) to provide a visual indication of location along the timeline and content of successive elements (e.g., scenes or chapters) of the main program. Prior to playback, the main thumbnail (and each additional thumbnail to be displayed with the main thumbnail) can be generated from the main program and prestored in association with the main program. Alternatively, the additional thumbnails and main thumbnail are generated from the main program in real-time during playback of the main program.

### BRIEF DESCRIPTION OF THE DRAWINGS

FIG. 1 is a display generated in accordance with the inventive method.

FIG. 2 is a block diagram of an embodiment of a media player (16) configured to generate the display of FIG. 1 and a storage medium 13 (e.g., a disk) which stores a video program (12) and thumbnail data (14) indicating content of the video program at a set of possible target locations within the program.

FIG. 3 is a block diagram of an embodiment of the inventive media player.

FIG. 4 is a computer readable medium which stores code for implementing an embodiment of the inventive method.

### DETAILED DESCRIPTION OF THE PREFERRED EMBODIMENTS

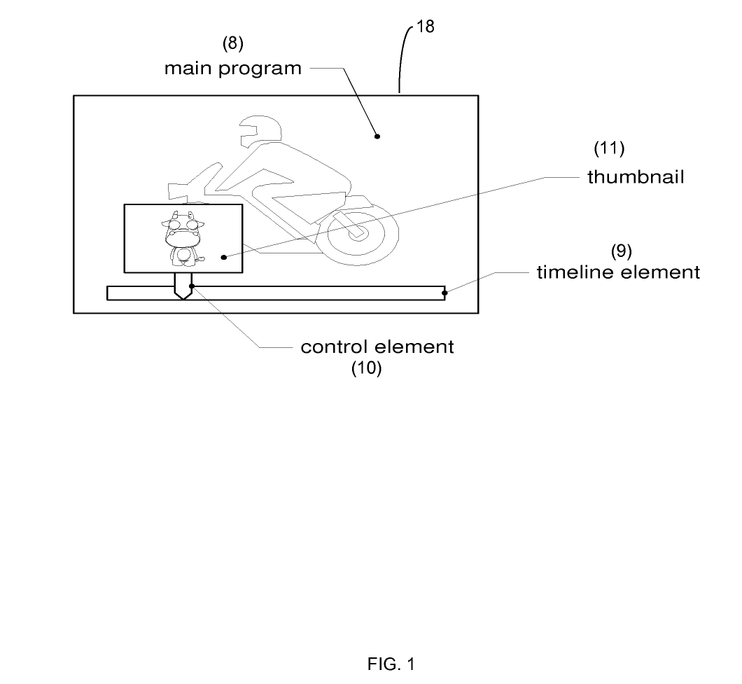

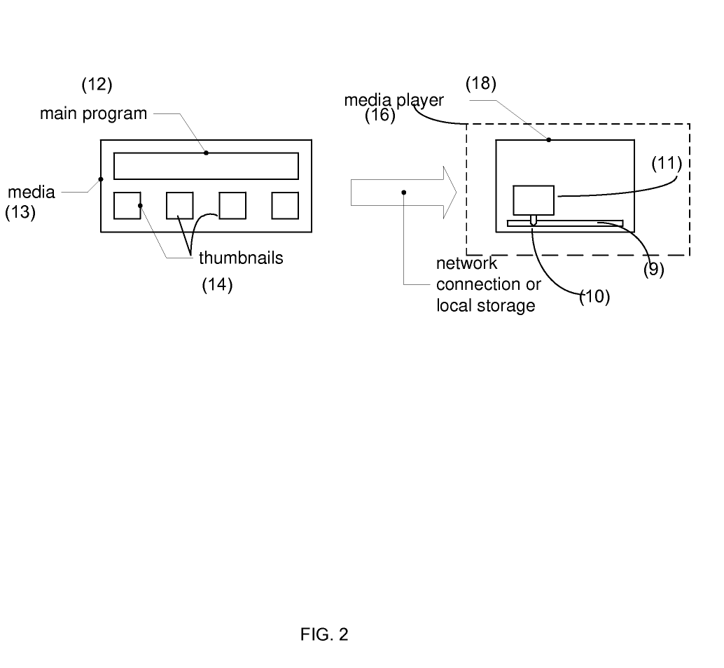

Many embodiments of the present invention are technologically possible. It will be apparent to those of ordinary skill in the art from the present disclosure how to implement them. An embodiment of the inventive method will be described with reference to FIGS. 1 and 2.

An aspect of the invention is a method for controlling playback of a video program by a media player including by providing, during playback of the program, at least one thumbnail indicative of content of the program at a selected target location in the program (to which the media player will typically be implemented to jump in response to an appropriate user command). Each thumbnail is visually indicative of content of the video program at a time (a “target time”) within the program corresponding to the target location. Typically the displayed thumbnail is updated in response to user selection of a sequence of different target locations (i.e., the method includes a step of displaying a sequence of thumbnails, each having appearance indicative of content of the program at different one of the target locations). Each thumbnail (or each of at least a subset of the displayed thumbnails) can be a compressed or reduced-scale version of an actual frame of the program, or a representative image of a chapter (or other segment) of the program including the current target location, or can provide some other visual indication of content of the program at a target location.

In accordance with preferred embodiments of the inventive method, a media player provides (including by displaying) not only such a thumbnail but also visual feedback indicative of a current target location in the program, during playback of the program. For example, the thumbnail and visual feedback of current target location can be elements of a timeline control displayed so as to overlie a portion of each displayed frame of the program being played back. Alternatively, the thumbnail (and other visual feedback) and video program are displayed in different areas of a display screen so that neither overlies the other.

In typical embodiments (including the embodiment to be described with reference to FIG. 1), the step of providing the thumbnail and other visual feedback includes a step of displaying a timeline control including a timeline, an icon, and the thumbnail. The current position of the icon (and typically also the thumbnail) along the timeline indicates a target location and thus a target time in the video program, and the icon is movable along the timeline in response to user selection of different target locations in the video program (typically accomplished by asserting commands to the media player using a mouse or other input device). Typically, the thumbnail moves with the icon in response to user selection of different target locations. The thumbnail's current (updated) appearance visually indicates content of the video program at the relevant target location (i.e., at a target time and target location corresponding to the icon's current position along the timeline).

In contrast, a traditional timeline control bar includes only a timeline and an icon that can be moved along the timeline (using an input device) to select a target location within a video program to which the media player will jump in response to a user command. A user can interactively move the icon of the traditional timeline control to select a target location within the video program, but is not provided any visual indication of what content will be displayed when playback begins at the target location.

Typical embodiments of the inventive method also provide an improvement over the DVD program chapter selection methods traditionally found on media players that play DVD programs, which require the user to stop playback to select a target chapter and provide no real-time visual feedback. In accordance with these embodiments, when a user selects a target location in a DVD program (or other video program) during playback of the program, the media player displays at least one thumbnail that is or includes a representative image of a chapter (or other segment) of the DVD or other program including the target location.

With reference to FIG. 1, a media player configured to perform an embodiment of the inventive method implements a user interface capable of displaying a timeline control 9 (including thumbnail 11) of the type shown in FIG. 1 on a display screen (e.g., display screen 18 of FIG. 1) during playback of a video program. During playback of the program, the player displays a sequence of frames (e.g., current frame 8) of the program on screen 18. A user can access the user interface to cause it to display timeline control 9 during playback. Typically, timeline control 9 is superimposed over (displayed in place of) a portion of the current frame 8 of the program as shown. Timeline control 9 includes a timeline indicating times at which elements of the program sequentially occur, and a timeline position control icon 10 which moves along the timeline (in response to user manipulation of an input device) to select a target location within the program.

Typically, timeline control 9 is displayed initially with the timeline and icon 10 but not thumbnail 11. Then, in response to an appropriate command (e.g., a user activation of control 9 by clicking on the displayed control using a mouse) the media player displays thumbnail 11 on screen 18 as an element of timeline control 9 adjacent to icon 10. Typically, thumbnail 11 is displayed superimposed over a portion of the video program being played back as shown in FIG. 1. Icon 10 can be moved (e.g., dragged by a user using a mouse or other input device) along the timeline using an input device to select a time within the video program to which the player will jump in response to a user command (asserted using the same or a different input device). Displayed thumbnail 11, whose position is preferably moved along the timeline with that of icon 10, visually indicates content associated with a currently selected target location in the video program (the target location is determined by icon 10's current position along the timeline). For example, when the user drags icon 10 to the position shown in FIG. 1 (corresponding to a specific target location), the media player moves thumbnail 11 along with icon 10 and updates thumbnail 11 to make it visually indicative of content of the video program (e.g., a front view of a motorcycle as shown in FIG. 1) at the newly selected target location.

Preferably, the appearance of displayed thumbnail 11 changes in real time as the user interacts with timeline control 9 (e.g., drags icon 10 along the timeline) to select different target locations within the program. The appearance of timeline control 9 (including the updated thumbnail 11) visually conveys to the user not only the current location of icon 10 along the timeline (and thus a user-selected target location within the program) but also an indication of content of the video program (provided by updated thumbnail 11) at the target location. The displayed thumbnail 11 can be implemented to show program content of any of a variety of types, including for example an actual scene (e.g., a compressed version of an actual frame) or chapter number of the video program at the target location determined by icon 10's current position, or a representative scene of the video program at the target location determined by icon 10's current position, or a representative image of a target chapter of the program which includes the target location determined by icon 10's current position. By viewing thumbnail 11, the user can intuitively select a target location within the program to which to command the media player to jump.

As described, a media player is preferably implemented to play back a video program while displaying a timeline control in accordance with the invention, thereby allowing a user to view the program while interacting with the timeline control to decide whether to jump to another location in the program and if so to select a target location to which to jump. Alternatively, the timeline control (including at least one thumbnail indicative of content of a video program at a target location) is displayed before a user initiates playback of the program or during a pause in playback of the program.

Rather than displaying a timeline control over (in place of) a portion of each displayed frame of a video program as in FIG. 1, alternative embodiments of the inventive method include a step of displaying a timeline control and playing back a video program with the timeline control and program in different areas of a display screen so that neither overlies the other.

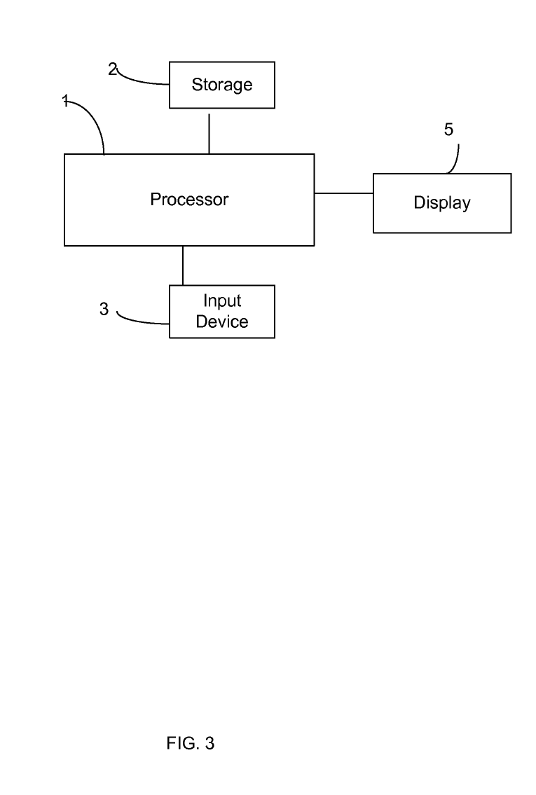

With reference to FIG. 2, in some embodiments of the inventive method thumbnail data (e.g., thumbnail data 14 of FIG. 2) that determine a set of thumbnails for a video program (e.g., video program 12) are generated from the video data comprising the program prior to playback of the program and stored with the program. For example, thumbnail data 14 that determine thumbnails of program 12 can be generated and stored with program 12 on storage medium 13 (e.g., a disk) of FIG. 2. The stored program 12 and thumbnail data 14 can later be read from storage medium 13 by media player 16 over a network connection or in a local storage subsystem within player 16 (e.g., in storage subsystem 2 of player 16 implemented as shown in FIG. 3), and used by player 16 to play back the program and generate displays of the type described above with reference to FIG. 1 (including timeline control 9 and a thumbnail 11 for the target location determined by the current position of icon 10 along the timeline) on display screen 18 of player 16. In one implementation, each thumbnail determined by thumbnail data 14 is a compressed version of a different frame of (i.e., a potential target location within) video program 12. Thumbnail data 14 may be generated automatically to determine thumbnails for locations at regular intervals within program 12 and/or may be generated to determine thumbnails at scene changes or logical break points within program 12 under editorial control.

Generation and storage of thumbnail data 14 in advance of program playback reduces (and can minimize) the computational overhead and communication bandwidth required for media player 16 to generate displays of the type described herein in accordance with the invention, and also allows media player 16 to load thumbnail data that determine an entire set of thumbnails without accessing or inspecting main video program 12 (or without accessing or inspecting video program 12 in its entirety) or indeed without performing any operation on program 12.

In alternative embodiments, thumbnail data are generated (e.g., by a media player) from a video program stream in real-time during playback of the video program. The thumbnail data are then stored for use by the media player's user interface to display (or generate and display) thumbnails in accordance with the invention.

An embodiment of the inventive media player will be described with reference to FIG. 3. The media player of FIG. 3 includes processor 1, video storage subsystem 2 (e.g., a DVD drive with a DVD inserted therein) and input device 3 (e.g., a mouse and/or a keyboard) coupled to processor 1, and display device 5 coupled to processor 1. Processor 1 is programmed to implement the inventive method in response to instructions and data entered by user manipulation of input device 3. For example, media player 16 of FIG. 2 can be implemented as shown in FIG. 3, with display device 5 including display screen 18. Typically, the media player of FIG. 3 is configured to allow a user to select a target location (a target playback position) within a video program intuitively using a timeline control displayed on display device 5, including by viewing content of the program (indicated by a thumbnail of the timeline control) at each of a number of potential target locations while viewing the video program as it is played by the media player.

In a typical implementation of the media player of FIG. 3, processor 1 is operable to cause display of a video program (sometimes referred to as a “main program”) on display device 5 to continue while a user interacts with a timeline control (also displayed on device 5) by manipulating input device 3 to move a displayed icon (indicative of a current target location within the program) along a timeline and views changes in appearance of a corresponding displayed main thumbnail (e.g., thumbnail 11 of FIG. 1 or 2) indicative of content of the program at the currently selected target location. Preferably, when a user double clicks on the icon (i.e., uses device 3 to assert a jump command) processor 1 jumps to the main program element at the current target location and playback of the main program commences at the target location. This results in display of content indicated by the main thumbnail's appearance at the time of the jump command.

In operation of some implementations of the media player of FIG. 3, processor 1 also causes additional thumbnails to be displayed on device 5 along the timeline (e.g., below the timeline while the above-described main thumbnail is displayed above the timeline) during playback of the main program to provide visual indication of location along the timeline and content of a sequence of elements (e.g., scenes or chapters) of the main program. The main thumbnail (and each additional thumbnail to be displayed with the main thumbnail) can be generated from the main program by a device or system external to the media player prior to playback, and then stored in subsystem 2 in association with the main program prior to playback of the main program. Alternatively, processor 1 is configured to generate the additional thumbnails and main thumbnail from a main program stream in real-time during playback of the main program (or by accessing the stored main program in subsystem prior to playback of the program).

In one implementation of the media player of FIG. 3, storage subsystem 2 is a semiconductor memory (e.g., a flash memory chip or chip set). In another implementation, storage subsystem 2 is a DVD drive, the media player is configured to play a video program including by reading a DVD (on which the program has been recorded) in the DVD drive. In the latter implementation, while the media player displays a timeline control of the type shown in FIG. 1 on device 5 during playback of the DVD program, in response to user selection of a target location in the program the media player displays thumbnail 11 with an appearance that is or includes a representative image of a chapter (or other segment) of the DVD program that includes the target location.

In some embodiments, the inventive media player (e.g., processor 1 of the FIG. 3 embodiment) is a device or system programmed with software to perform an embodiment of the inventive method. In other embodiments, the inventive media player (e.g., processor 1 of the FIG. 3 embodiment) is a device or system programmed with firmware to perform an embodiment of the inventive method. In other embodiments, the inventive media player is software or firmware that programs a processor (or processing system) to perform an embodiment of the inventive method.

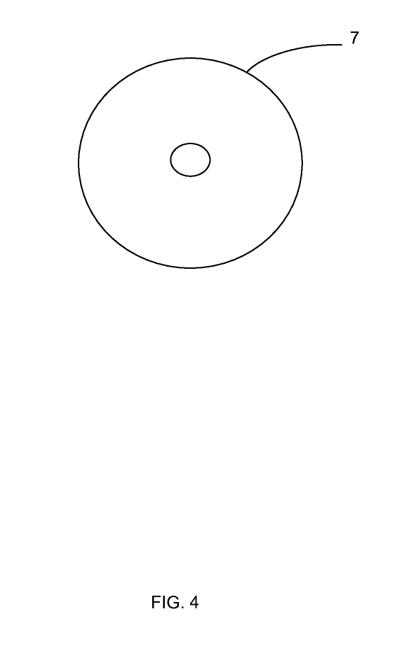

Another aspect of the invention is a computer readable medium which stores code for implementing any embodiment of the inventive method. For example, computer readable optical disk 7 of FIG. 4 is a computer readable medium which has computer readable code stored thereon. The code is suitable for programming processor 1 to implement an embodiment of the inventive method.

While specific embodiments of the present invention and applications of the invention have been described herein, it will be apparent to those of ordinary skill in the art that many variations on the embodiments and applications described herein are possible without departing from the scope of the invention described and claimed herein. It should be understood that while certain forms of the invention have been shown and described, the invention is not to be limited to the specific embodiments described and shown or the specific methods described.

What is claimed is:

1. A method for controlling playback of a video program, including the steps of:
(a) playing the video program; and
(b) during step (a), selecting a target location in the video program and displaying a thumbnail that is visually indicative of content of the video program at said target location.

2. The method of claim 1, also including the step of:
during step (b), selecting a new target location in the video program and updating the thumbnail so as to display an updated thumbnail that is visually indicative of content of the video program at the new target location.

3. The method of claim 1, wherein the thumbnail is a reduced-scale version of a frame of the video program.

4. The method of claim 1, wherein the thumbnail is a representative image of a segment of the video program, and the segment includes the target location.

5. The method of claim 1, wherein step (a) includes the step of operating a media player to play the video program, and said method also includes the step of:
while displaying the thumbnail, asserting a command to the media player to cause the media player to jump to the target location in the video program to commence playback of the video program at said target location.

6. The method of claim 1, wherein step (b) includes the step of:
providing visual feedback indicative of the target location in the video program.

7. The method of claim 1, wherein step (a) includes the step of operating a media player to play the video program, and step (b) includes the step of:
in response to assertion of at least one command to the media player, displaying a timeline control including a timeline, an icon, and the thumbnail, wherein current position of the icon along the timeline indicates the target location in the video program.

8. The method of claim 7, said method also including the step of:
during step (b), selecting a new target location in the video program, moving the icon to a new position along the timeline indicative of the new target location, and updating the thumbnail so as to display an updated thumbnail that is visually indicative of content of the video program at the new target location.

9. The method of claim 1, said method also including the step of:
during step (b), selecting a new target location in the video program, moving the icon and the thumbnail to new positions along the timeline indicative of the new target location, and updating the thumbnail so as to display an updated thumbnail that is visually indicative of content of the video program at the new target location.

10. The method of claim 1, wherein step (a) includes the step of operating a media player to play the video program, and said method also includes the step of:
(c) before step (a), generating thumbnail data that determine the thumbnail from video data that determine the video program, and providing the thumbnail data and the video data to the media player.

11. The method of claim 10, wherein the media player includes a storage subsystem, and step (c) includes the step of:
storing the thumbnail data and the video data in the storage subsystem.

12. A method for controlling playback of a video program, including the steps of:
(a) operating a media player to play the video program; and
(b) during step (a), displaying a timeline control including a timeline, an icon, and a thumbnail, such that current position of the icon along the timeline indicates a target location within the video program and current appearance of the thumbnail indicates content of the video program at the target location.

13. The method of claim 12, said method also including the step of:
during step (b), moving the icon to a new position along the timeline to select a new target location in the video program, wherein the new position along the timeline is indicative of the new target location, and updating the thumbnail so as to display an updated thumbnail that is visually indicative of content of the video program at the new target location.

14. The method of claim 12, said method also including the step of:
during step (b), moving the icon to along the timeline to select a sequence of new target locations in the video program, while updating the thumbnail in real-time so as to display a sequence of updated thumbnails that are visually indicative of content of the video program at each of the new target locations.

15. The method of claim 12, also including the step of:
(c) before step (a), generating thumbnail data that determine the thumbnail from video data that determine the video program, and providing the thumbnail data and the video data to the media player.

16. The method of claim 15, wherein the media player includes a storage subsystem, and step (c) includes the step of:
storing the thumbnail data and the video data in the storage subsystem.

17. A media player, including:
a display subsystem; and
a processing subsystem coupled to the display subsystem and configured to cause video data, indicative of a video program, to be asserted to the display subsystem for display by said display subsystem, wherein the processing subsystem is configured to respond to selection of a target location in the video program during display of the video program by causing the display subsystem to display a thumbnail that is visually indicative of content of the video program at said target location.

18. The media player of claim 17, wherein the processing system is configured to respond to selection of a new target location in the video program during display of the video program by causing the display subsystem to display an updated thumbnail that is visually indicative of content of the video program at the new target location.

19. The media player of claim 17, wherein the thumbnail is a reduced-scale version of a frame of the video program.

20. The media player of claim 17, wherein the thumbnail is a representative image of a segment of the video program, and the segment includes the target location.

21. The media player of claim 17, wherein the processing subsystem is configured to respond to assertion of a jump command during display of the thumbnail by jumping to the target location in the video program and causing the display subsystem to commence playback of the video program at said target location.

22. The media player of claim 17, wherein the processing subsystem is configured to respond to selection of the target location in the video program during display of the video program by causing the display subsystem to display a timeline control including a timeline, an icon, and the thumbnail, such that position of the icon along the timeline indicates said target location within the video program.

23. The media player of claim 22, wherein the processing subsystem is configured to respond to selection of a sequence of new target locations in the video program by causing the display subsystem to move the icon along the timeline to positions indicative of the new target locations while updating the thumbnail in real-time to display a sequence of updated thumbnails that are visually indicative of content of the video program at each of the new target locations.

24. The media player of claim 17, also including:
a storage subsystem coupled to the processing subsystem,
wherein said media player is configured to receive, and store in the storage subsystem prior to display of the video program, thumbnail data that determine the thumbnail and said video data, and the processing subsystem is configured to respond to selection of the target location in the video program cause by causing the thumbnail data to be asserted from the storage subsystem to the display subsystem.

25. The media player of claim 17, wherein the processing subsystem is programmed with a user interface that responds to selection of the target location in the video program during display of the video program by causing the display subsystem to display a timeline control including a timeline, an icon, and the thumbnail, and wherein the user interface is configured to respond to user commands that select a sequence of new target locations in the video program by causing the display subsystem to move the icon along the timeline to positions indicative of the new target locations while updating the thumbnail in real-time to display a sequence of updated thumbnails that are visually indicative of content of the video program at each of the new target locations.

26. A computer readable medium which stores code for programming a media player to control playback of a video program including by:
playing the video program; and
responding to selection of a target location in the video program being played by displaying a thumbnail that is visually indicative of content of the video program at said target location.

27. The medium of claim 26, wherein the code is for programming the media player to control playback of the video program including by responding to selection of a new target location in the video program being played by updating the thumbnail so as to display an updated thumbnail that is visually indicative of content of the video program at the new target location.

28. The medium of claim 26, wherein the code is for programming the media player to control playback of the video program including by responding to assertion of a jump command to the media player during display of said thumbnail by jumping to the target location in the video program and commencing playback of the video program at said target location.

29. The medium of claim 26, wherein the code is for programming the media player to respond to selection of the target location by displaying a timeline control including a timeline, an icon, and the thumbnail, wherein current position of the icon along the timeline indicates the target location in the video program.

30. The medium of claim 29, wherein the code is for programming the media player to respond to selection of a sequence of new target locations in the video program being played by moving the icon to along the timeline to positions indicative of the new target locations while updating the thumbnail in real-time so as to display a sequence of updated thumbnails that are visually indicative of content of the video program at each of the new target locations.
